(19) United States
(12) Patent Application Publication
(10) Pub. No.: US 2013/0054468 A1
(43) Pub. Date: Feb. 28, 2013

(54) SYSTEM AND METHOD FOR CONDUCTING FINANCIAL TRANSACTIONS

(71) Applicants: Federico L. Fuentes, Aventura, FL (US); Ricardo A. España, San Antonio de los Altos Edo Miranda (VE); Carlos E. Convit, Caracas (VE)

(72) Inventors: Federico L. Fuentes, Aventura, FL (US); Ricardo A. España, San Antonio de los Altos Edo Miranda (VE); Carlos E. Convit, Caracas (VE)

(73) Assignee: Platamovil International BV

(21) Appl. No.: 13/217,634

(22) Filed: Aug. 25, 2011

(51) Int. Cl. G06Q 20/00; G06Q 40/00

(52) U.S. Cl. 705/64; 705/44; 705/21; 705/43

(57) ABSTRACT

Systems and method of the present invention include a comprehensive system architecture that enables access to Non-bank financial institutions (NFBIs) and banks through point-of-sale devices and mobile telephones, for example. The present invention involves use of a modified ISO 8583 standard to allow users to interface with a front end processing system directly from non-traditional devices. The present invention also allows mobile banking with the NBFI through use of an application residing in a user's mobile telephone, which allows the encapsulation of user information as XML, for example, and the transmission of those over http while complying with the ISO 8583 standard, and further allowing encryption of certain user data, without having to resort to access to mobile banking website. In one aspect of the invention, a POS application may run on top of PCI to enable users to make purchases using funds pre-deposited in an NBFI account.

### FIELD OF THE INVENTION

The present invention relates to data processing systems and methods for conducting financial transactions over a network. More particularly, the present invention relates to integrated systems and methods which provide secure access to capital and that enable financial transactions by using wireless technology, such as mobile devices.

### BACKGROUND OF THE INVENTION

Businesses dedicated to cashing checks and bill payment on behalf of others are striving in the United States and other parts of the world as well. Low income families are practically forced to use these services due to high fees charged by banks for keeping a low balance in an account and due to high initial deposit requirements to open an account. Migrant workers are also forced to use these services as banks do not allow an individual to open an account without providing an address in the U.S. Overall, a large percentage of the population in the U.S. has no access to capital or financial services through banks. This is something that check cashing companies take advantage of by making short-term loans at a very high interest. These conditions have created a problem that essentially jeopardizes the safety of individuals that always carry cash. These conditions also potentially create a problem in that they may affect a taxing authority's ability to collect taxes for transactions that cannot be traced.

Non-bank financial institutions (“NBFIs”)have become an efficient alternative to banks in terms of providing financial services to individuals with limited wealth or economic resources. The service of accepting monetary deposits from the public is typically regulated or controlled by state or federal law and regulations and these NBFIs are not exempt from such laws or regulations. At a global level, these NBFIs allow wider access to financial services, especially to individuals that reside far from big cities. In fact, one of the main aspects that limit worldwide ease of access to banks is the scarcity of branches that offer client services, etc. Not surprisingly, one of the goals of NBFIs is to increase the number of locations where clients can be serviced by increasing the number of non-traditional channels, authorizing banking institutions to offer financial services through the NBFIs, such as stores, supermarkets, etc. While, NBFIs constitute a tool against financial exclusion, there is a still a need for a system to allow easier access to capital or financial services through NBFIs and banks.

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present invention includes a comprehensive system architecture that enables access to NBFIs (or banks) through point-of-sale devices and mobile telephones, for example. In one embodiment of the present invention, the ISO 8583 standard is expanded so as to allow users to interface with a front end processing system directly from non-traditional devices.

In another embodiment of the present invention, mobile banking with the NBFI or banks can be achieved through use of an application residing in a user's mobile telephone, which allows the encapsulation of user information as XML, for example, and the transmission of those over http while complying with the aforementioned ISO 8583 expansion, and further allowing encryption of certain user data. In yet another embodiment of the present invention, a POS application may run on top of the PCIstandard to enable users to make purchases using funds pre-deposited in an NBFI account. To achieve this, the POS application may initiate a session with the NBFI or bank and use an encrypted message obtained through that first session to encrypt information as part of a second session which will then be used to finalize the transaction while the first session expires.

The following description and the annexed drawings set forth in detail certain illustrative aspects of the invention. These aspects are indicative, however, of but a few of the various ways in which the principles of the invention may be employed and the present invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 illustrates a financial transaction architecture in accordance with one embodiment of the present invention;

FIG. 2 illustrates a method for setting up a user account in accordance with one embodiment of the present invention;

FIG. 3 illustrates a method for electronic transfer of cash to another account in accordance with one embodiment of the present invention;

FIG. 4 illustrates a method for obtaining a one-time use PIN for use an ATM in accordance with one embodiment of the present invention;

FIG. 5 illustrates a method for electronic processing of cash withdrawal through use of POS in accordance with one embodiment of the present invention;

FIG. 6 illustrates a method for electronic processing of purchases at a merchant's location in accordance with one embodiment of the present invention;

FIG. 7 illustrates a method for electronic processing of payroll disbursement in accordance with a first embodiment of the present invention;

FIG. 8 illustrates a method for electronic processing of payments to payees in accordance with a second embodiment of the present invention; and

FIG. 9 illustrates a flow of transactions related to the electronic processing of purchases or cash withdrawals in accordance with one embodiment of the present invention.

### DETAILED DESCRIPTION OF ILLUSTRATIVE EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

As will be appreciated by those skilled in the art, portions of the present invention may be embodied as a method, data processing system, or computer program product. Accordingly, these portions of the present invention may take the form of an entirely hardware embodiment, an entirely software embodiment, or an embodiment combining software and hardware aspects. Furthermore, portions of the present invention may be implemented as a computer program product on a computer-usable storage medium having computer readable program code on the medium. Any suitable computer readable medium may be utilized including, but not limited to, static and dynamic storage devices, hard disks, optical storage devices, and magnetic storage devices.

The present invention is described below with reference to illustrations of methods, systems, and computer program products according to embodiments of the invention. It will be understood that blocks of the illustrations, and combinations of blocks in the illustrations, can be implemented by computer program instructions, hardware devices, or a combination of both. These computer program instructions may be provided to a processor of a general purpose computer, special purpose computer, or other programmable data processing apparatus to produce a particular machine, such that the instructions, which execute via the processor of the computer or other programmable data processing apparatus, implement the functions specified in the block or blocks.

### Transactions Implemented Through Modified ISO 8583

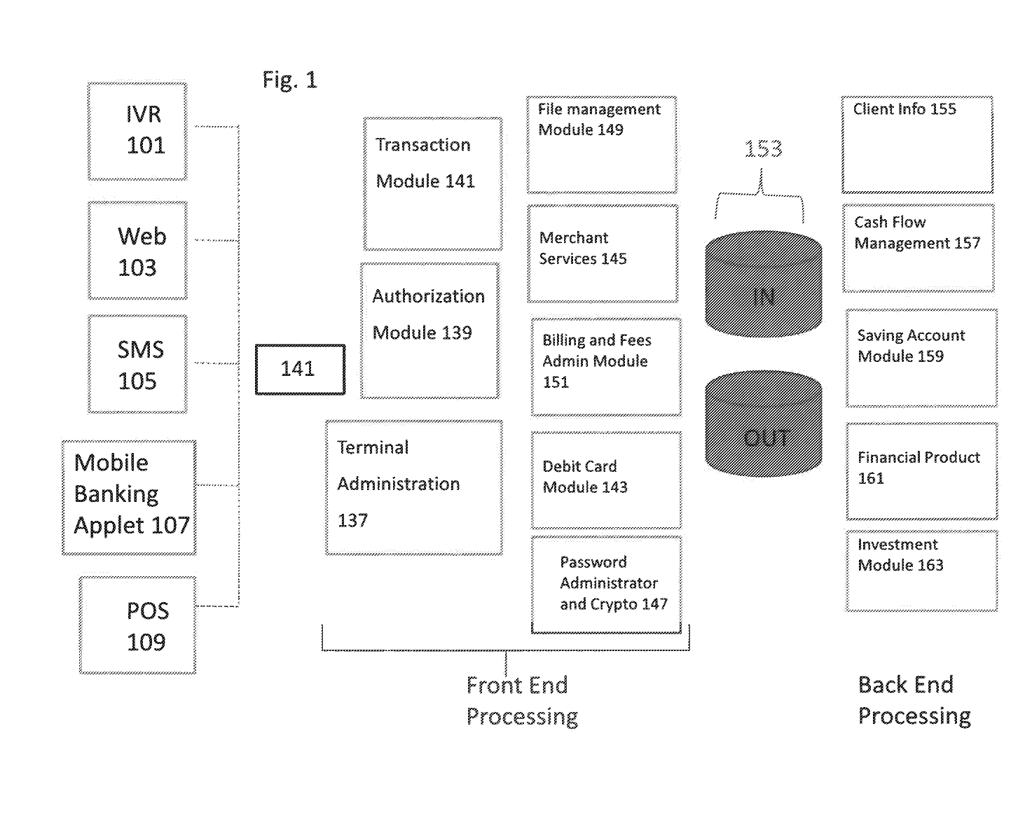

FIG. 1 illustrates an exemplary architecture of the system of the present invention in accordance with one embodiment. The system includes a number of front end processing modules that interface with remote devices through an ISO 8583 messaging interface 141 modified in accordance with the present invention. Although ISO 8583 defines a common standard, it is not typically used directly by financial transactional systems or networks. Instead, each network adapts the standard for its own use with custom fields and custom usages.

The placement of fields in different versions of the standard varies. For example, the currency elements of the 1987 and 1993 versions of the ISO 8583 standard are no longer used in the 2003 version, which holds currency as a sub-element of any financial amount element. As of the time of this writing, ISO 8583:2003 has yet to achieve wide acceptance.

An ISO 8583 message is made of the following parts:
Message type indicator (MTI)
One or more bitmaps, indicating which data elements are present
Data elements, the fields of the message.

The remote devices or systems that can access the system of the present invention include an electronic cash register (ECR) (not illustrated); an Interactive Voice Response (IVR) module 101, a point-of-sale device (POS) 109, which may communicate with a near field communications reader (NFC) to read information from a credit card or mobile device, for example; a computing device with access to the Internet (Web) 103; a cell phone with an application for mobile banking (MB) 107; and a remote device capable of receiving SMS messages (SMS) 105. Remote devices 101, 103, 107, and 109, may communicate with the API 141 through the Internet or Access point Network (APN) circuitry. Some of these are “smart” remote devices that can assemble a modified ISO 8583 message and send it to the API 141. For other devices with limited capabilities, a client management service (CMS) (not illustrated) may be used for assembling a modified ISO 8583 message and forward the corresponding modified ISO 8583 message to the API 141. For example, The CMS verifies information received from the devices before assembling the modified ISO 8583 message. In general, the CMS verifies that a particular cell phone number exists, as in one embodiment of the present invention a user's cell phone number is used as the account number, verifies that the user account is active, and checks that the maximum number of allowances (e.g., number of transactions allowed per month, day, etc.) has not been exceeded. The information verified and provided by the CMS may be used in assembling modified ISO 8583 messages. The CMS may then send the modified ISO 8583 message to the AP 141 or it can forward verification parameters to a smart device for assembly of the ISO 8583 modified message.

As mentioned, the remote devices can be used for exchanging modified ISO 8583 messages with the API 141, which resides in a switching server. Other components of the switching server may include a switch module, an ATM module, an ACH module, and a module for interfacing with other networks. One of the functions of the API 141 is to convert the modified ISO 8583 messages into standard ISO 8583 messages. Another function includes passing those ISO 8583 messages to other modules which are part of the system of the present invention, for example the terminal administration module 137 or the authorization module 139. When the API 141 conducts messaging with those modules, for example, the financial transaction is referred to as a closed loop transaction. When the API 141 exchanges messages with a switch module, the ACH module or the other network module in the switch server, the messages from the API 141 leave the network architecture illustrated in FIG. 1, and as such, the transactions involving that type of messaging are referred to as open loop transactions, as would be understood by a person of ordinary skill in the art.

The system of the present invention may include front end processing modules (FEP). In one embodiment of the present invention, the FEP includes acquirer modules (i.e., modules 137-141 that acquire instructions or commands from the remote devices) and processing modules (i.e., modules 143-151 that execute instructions for reading or writing information into the database 153). The FEP may be implemented in a server separate from the switching server. In one embodiment of the present invention, the acquirer and processing modules can be implemented as separate virtual machines running on the same server.

The FEPacquirer modules may include a terminal administration module 137, an authorization module 139 and a transaction module 141. The terminal administration module 137 is used to process requests from POS and ECR devices. These requests may include identification of the POS or ECR, origination account information, destination account information, and amount of transaction and of transaction fee.

In one embodiment, transaction requests from remote devices other than a POS or ECR may be passed by the API 141 directly onto the authorization module 139. The authorization module 139 verifies whether the account to be debited has enough balance to complete the transaction, that the PIN entered for user authentication (e.g., PIN1) matches the PIN stored in the database 153, and verifies that the number of allowance are met. The PIN is recreated internally by the password and cryptography module 147, which may be implemented as a hardware-based cryptography card. Upon authorization, the module 139 issues an authorization code. In one embodiment, the last two digits of the authorization code may be used as a temporary/onetime use code (i.e., PIN2) to conduct ATM transactions or purchase transactions.

The authorization code is passed on to the transaction module 141, which generates instructions to write credits to accounts, post debit to accounts, as well as fees. For example, if the transaction requested is for a purchase, the transaction module 141 instructs the merchant services module 145 to write a credit to the merchant account in the database 153, instructs the debit card module 143 to write a debit to the user's account in the database 153, and instructs the billing and administrative feed module 151 to post a fee associated with the transaction. As transactions are completed, the file management module 149 keeps a record of the transactions processed (e.g., time of transaction, etc.). 141

In another aspect of the present invention, the database 153 is shared by the FEP modules and the back end processing (BEP). In the illustrated embodiment, the BEP modules include client information module 155, cash flow management module 157, savings account module 159, financial product module 161, and investment module 163. These BEP modules are associated with traditional banking functions. In one embodiment, they may be implemented as modules used to create reports containing basic client information (155), information about a client's cash flow management (157), information regarding a client's savings (159), information about financial products used by a client (161), and information about a client's investments (163).

One of the advantages of the present invention is that users of the system can activate or create accounts without the need to undergo all the formalities imposed under a traditional banking model. Consequently, some of the more traditional banking functions associated with the BEP processing may not be necessary for a user of the present invention. For example, in a preferred embodiment, a user may go to a store or merchant that operates a POS to open an account with an NBFI or bank, or to open with an NBFI or bank a prepaid debit account having a limit in terms of number of transactions and cash limit as well as means for reporting money laundering to authorities. The system still allows these transactions to take place on site. The present invention does not inhibit the KYC (Know Your Client) process if mandatory and the BEP allows processing of transactions that involve face to face contact for account creation or the simplified account creation process of the preferred embodiment of the present invention. The user or new client would hand cash to the merchant to deposit into an account associated with the mobile telephone number of that client. Using the IVR interface 101, a client of an NBFI or bank implementing the system of the present invention may dial in to the system to find out balance information, authorize transactions, etc. Using the web interface, a user of the system, for example an employer, may log in to the system and authorize payroll payments by transferring funds from an NBFI or bank, for example, to an employee account. Also, the system of the present invention may send text messages (e.g., SMS) to confirm that transactions have been completed. These exemplary transactions will be discussed below in more detail.

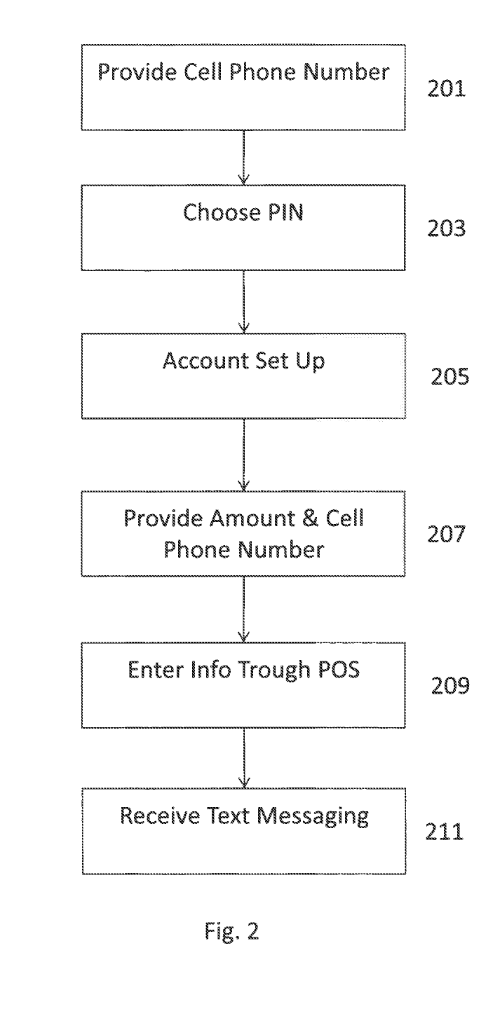

FIG. 2 illustrates one type of transaction that may be performed through use of a POS in which a new client of the NBFI or bank using the present invention can activate an account at a merchant's location. The merchant is appointed as an Independent Correspondent or authorized store by the bank or NBFI. A client can make an initial deposit at a selected location, for example at any of the associated stores or Independent Correspondents. In step 201 a merchant would enter into the POS 109, for example, the cell phone number associated with the new client. The client would wait until the system calls him/her to verify the identification of the owner of the cell phone. The client would then choose a PIN (step 203) and this PIN is entered into the POS connection to the FEP to approve a requested authorization by the POS device, which is part of account setup step 205, to reinitiate the completion of the request by entering a temporary code provided to the Merchant by the system, enabling the transaction to go forward with all included parameters enabled by the exchange of information between the account holder (via the Telephone), the merchant providing invoicing and allowing electronic payment with confidentiality of information, and the validation and decision by the consumer to complete the payment, and notification of the decision with the temporary code to Merchant's POS operator. The POS will then get confirmation and additional parameters to verify the validity and information about owner of the account. The system of the present invention would then setup the account in step 205. Upon receipt of cash and upon account activation methods by NBFI or Bank, the merchant may enter the account holder's cell phone number into the POS 109 in steps 207 and 209 to credit the account upon receiving cash for “loading” the account. After the account has been funded, the client receives a text message via a Short Message System (SMS) confirmation of the transaction in his cell phone through an SMS message (on top of previous amount to debit from his Account by IVR), for example (step 211).

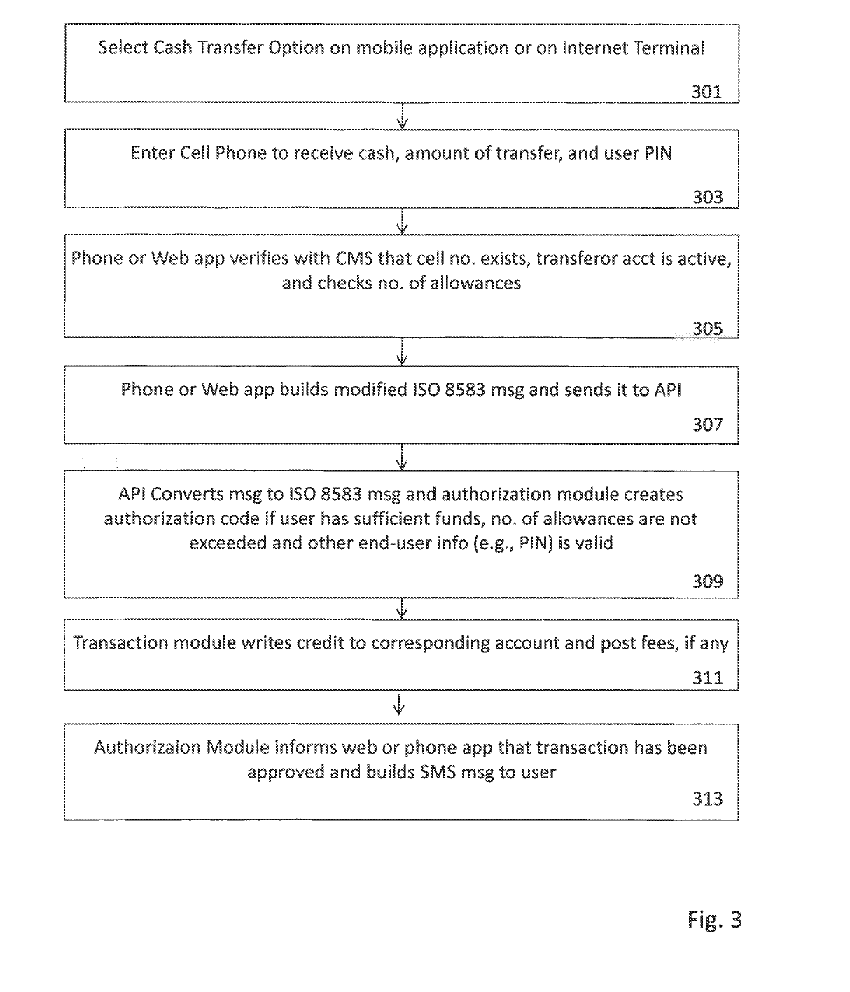

FIG. 3 illustrates a method for transferring cash from one NBFI or bank account holder to another. In step 301 the user selects the cash transfer option from a menu displayed by the MB 109 or Web 107, for example after the MB 109 or Web 107 recognizes a particular transfer or account, the user then enters the cell phone number associated with the other account holder (step 303) or debit card number at destination account as well as the amount to be transferred and the user authentication PIN (i.e., PIN 1). The application installed in the terminal Web 107 or cell phone MB 109 then communicates with the CMS to obtain verification that the cell phone numbers exist (enabled by network signaling and data base at CMS with registered numbers and associated account), that the accounts are active and checks the total number of allowances for the transferor (step 305). In step 307 the web or phone application builds a modified ISO 8583 message based on the information provided by the CMS and sends it to the API 141.

In step 309 the API 141 converts the received message from modified ISO 8583 to standard ISO 8583 and the authorization module 139 issues an authorization code if the user account has sufficient funds, the number of allowances is not exceeded, and other end-user information, such as the PIN, is validated. In step 311 the transaction module 141 communicates with merchant services module 145 and debit card module 143 and instructs these modules to post the appropriate debit and credit in the database 153 with respect to the accounts involved in the transaction. The transaction module also instructs the module 151 to calculate and post the fee associated with the transaction, if any. In step 313 the authorization module informs the web or phone application residing in Web 107 or MB 109 that the transaction has been approved and also builds a message that is sent to the user through the SMS interface 111. The transferor and the transferee receive a text message confirmation (e.g., SMS) of the transfer.

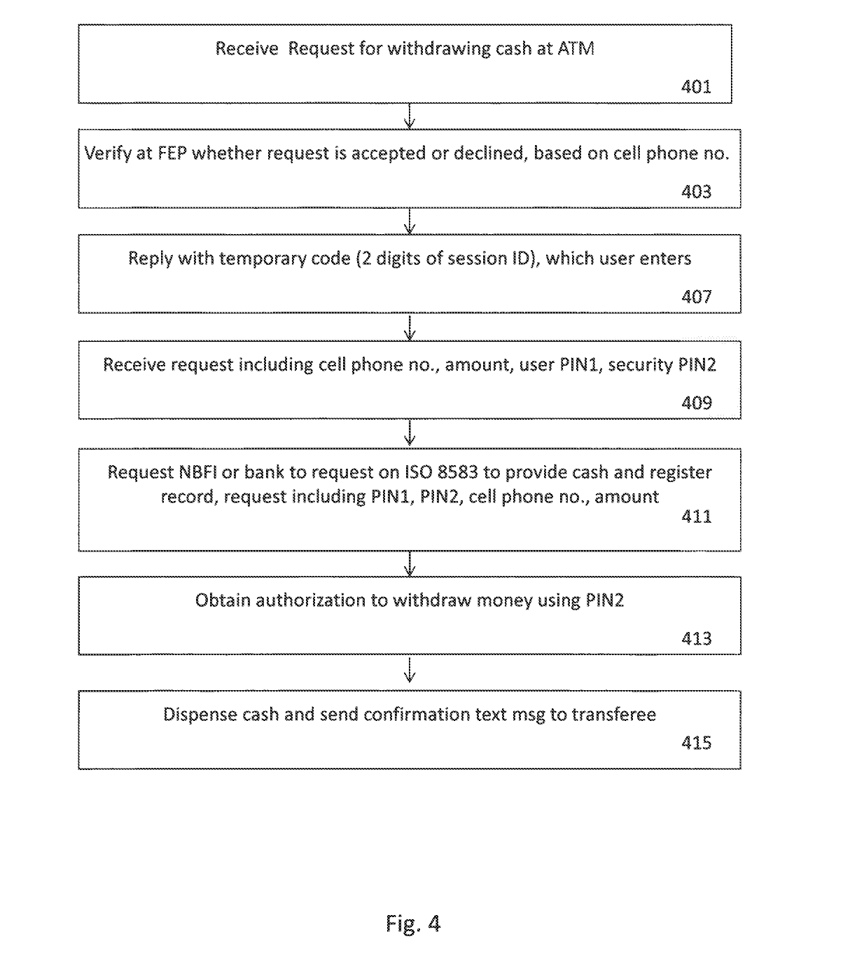

FIG. 4 illustrates a method for retrieving cash from an NBFI or bank authorized ATM in accordance with one embodiment of the present invention. This transaction is prepared by the Client (end User) in advance for a specific amount using IVR functionality. In step 401 the system receives a request for withdrawing cash at an ATM, for example a franchised ATM to brand or enable an ATM Network with the present system's non-card request. If the request is made at the ATM, the request may be triggered by a soft key or a button pressed by the user to indicate that the user seeks to withdraw cash without using an ATM card. The request may be accompanied by the user's cell phone number. Before sending the request to the API 141, the ATM communicates with the CMS Database to determine whether the user account is valid, etc. In step 403, the ATM sends the request to the authorization module 139 in the FEP through an ATM interface (ATM HUB Application for switching the transaction to FEP using the standard ISO8583 messaging) and the FEP determines whether the request is accepted or declined (according to the parameters set by user requests when preparing the ATM withdrawal request through the IVR), based on whether the account associated with the cell phone number is active as a first check to approve/decline before proceeding. If the request is not accepted, the system generates a reply with a message denying the request for withdrawal. For example, the user may receive a text message (or the ATM may display such message) that the request has been denied. In step 407, if the request is accepted, the user may receive a text message with a temporary authorization code to enter (PIN2). In one embodiment, this temporary code may be the last two digits of an authorization code generated by the authorization module 139 in response to the original request.

In step 409, the user may enter the temporary code along with a user PIN (PIN1) and amount to be withdrawn. In step 411, the ATM requests the licensed NBTI or bank to request an ISO8583 authorization to provide cash. While this request is based on ISO8583, the communications between the ATM and the FEP are based on the modified ISO8583 of the present invention. In step 413, the issuer (licensed bank or NBFI) authorizes the cash withdrawal based on PIN2 as well as additional parameters. In step 415, the ATM receives and processes information for authorizing the transaction, it dispenses the cash, and an SMS message is sent to the user confirming the transaction.

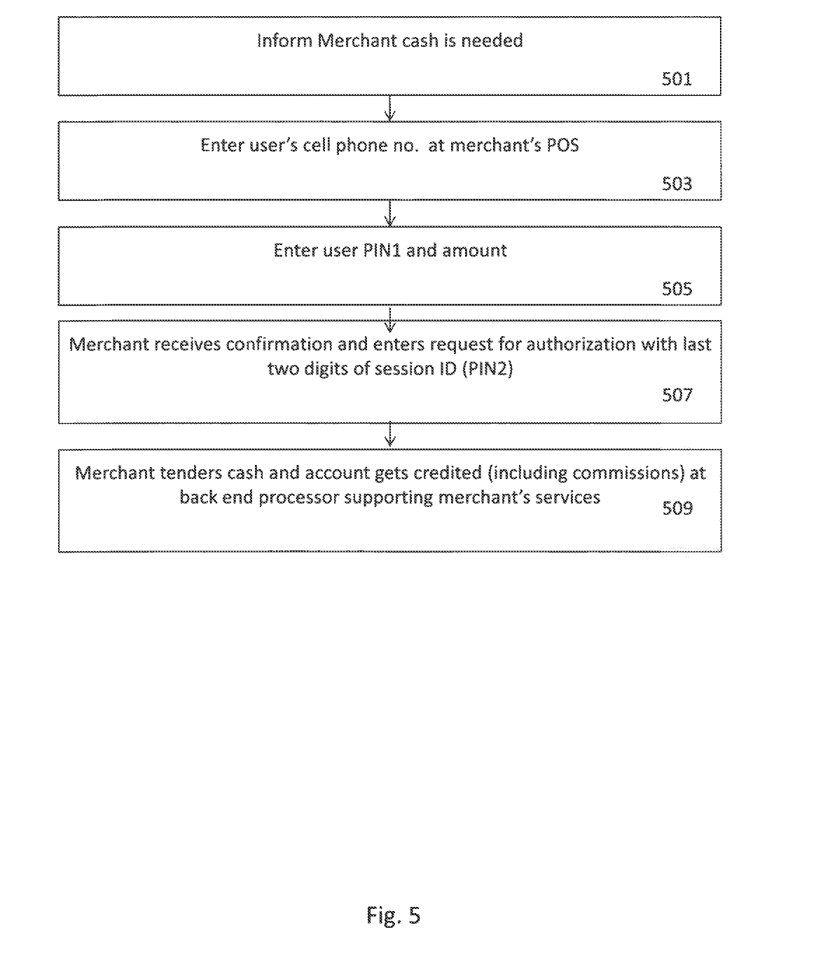

FIG. 5 illustrates at a high level a method for the retrieval of cash at a merchant location, for example. A more specific method may be implemented by using a method similar to the method described with respect to FIG. 4 except that the user interface would be a POS instead of an ATM. Referring to FIG. 5, in step 501 a user requests the merchant for cash. In step 503 the merchant enters the end- at the POS. In step 505 the merchant enters the user's cell phone number, amount of withdrawals, and PIN1 into the POS application. In step 507 the merchant enters request for authorization with PIN2 (last two digits of session ID to be included in a POS transaction to complete the ISO8583 modified request or complete the authorization) receives text with confirmation that it can tender cash to the user, assuming the user has funds. In step 509 the merchant tenders cash and the merchant's account gets credited at the backend processor supporting the merchant's services.

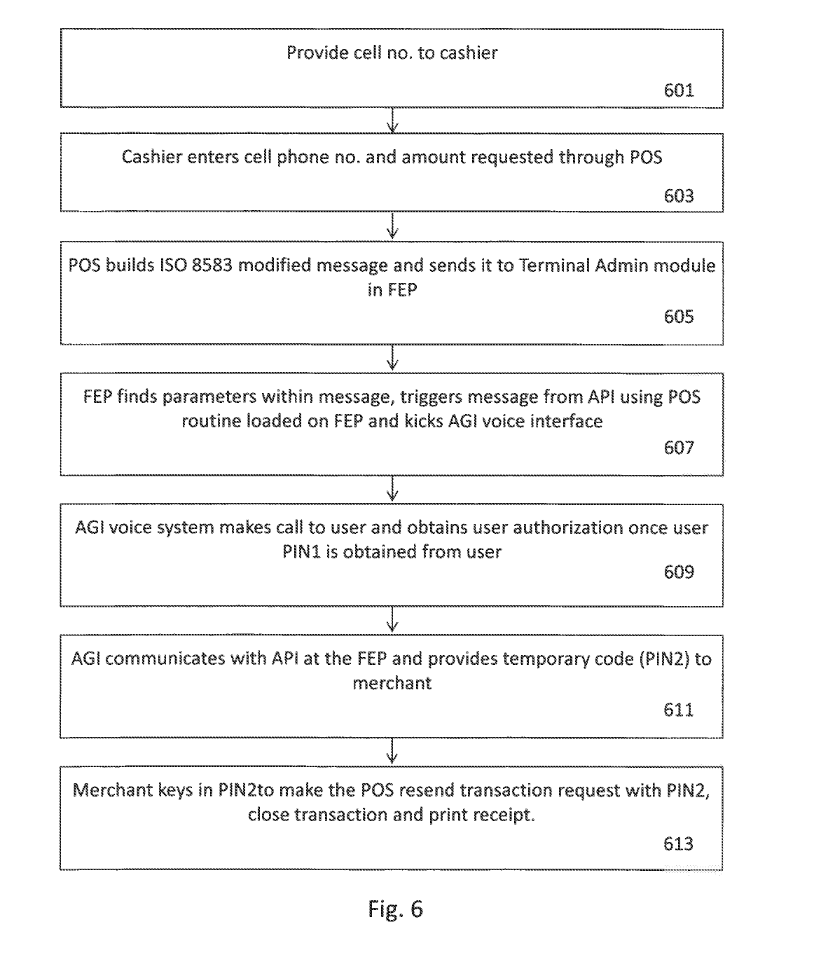

FIG. 6 illustrates a method for purchasing goods at a merchant's location. After the cashier has obtained the total amount owed for the sale of goods, the user provides a cell phone number associated with the NBFI or bank account to the cashier (step 601). At step 603 the cashier enters, through an ECR (or a POS device), the cell phone number and the amount owed into the system. In step 605, the ECR builds a modified ISO8583 message requesting authorization and sends it to the Terminal Administration Module 137 in the FEP. In one embodiment, the modified ISO 8583 message is built after verification of certain user data is received from CMS, as described above. In step 607 the FEP finds the variable part parameters in the message, triggers a message from the API 141 using a POS/ECR routine loaded on the FEP, and starts the voice interface routine (AGI, which stands for Asterisk Graphics Interface). The AGI voice system makes a call to the user and obtains user authorization once user enters his/her PIN number associated with the account (step 609). In step 611 the AGI communicates with the API at the FEP and provides a temporary code for user. In one embodiment, the temporary code may be the last two digits of an authorization code issued by the authorization module 139. In step 613, the merchant keys in the temporary code provided by the user to force the ECR/POS to restructure the modified ISO 8583 message, send the message to the API 137, and close the transaction.

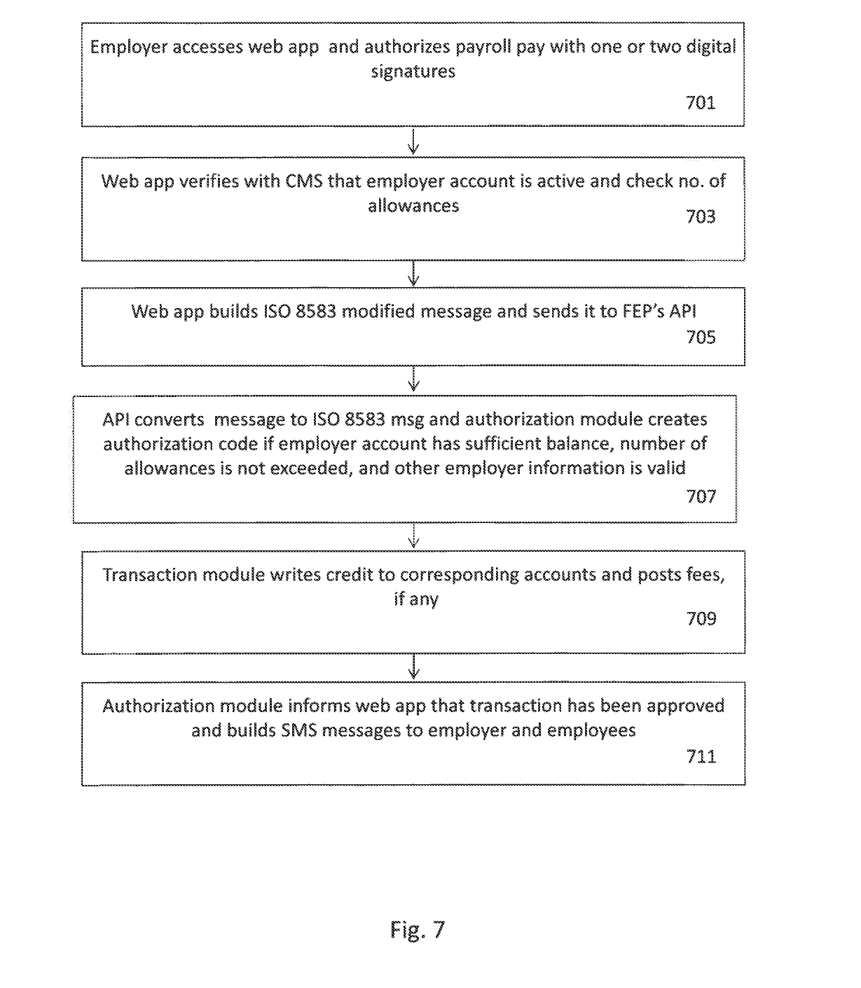

FIG. 7 illustrates a method that may be used by an employer to make payroll payments to its employees. In step 701 the employer logs into its account through a web interface and then authorizes the payroll disbursement. This payment may be a transfer from one NBFI or bank account into one or more NBFI or bank accounts. In step 703 a web application requests that the CMS Database verify that the employer account is active, for example, and that the number of allowances associated with the employer account has not been exceeded. Upon verification, in step 705 the web application builds a modified ISO8583 message and communicates the message to the API 141. In step 707, the API 141 converts the message to a standard ISO8583 message, and the authorization module 139 issues an authorization code if the employer account has sufficient balance, the number of allowances is not exceeded, and other employer information is valid. In step 709 the transaction module 141 instructs the corresponding processing modules in the FEP to write credits and debits to the employer and employee accounts, together with the associated fees. In step 711 authorization module informs the web application that the transactions have been approved and builds SMS messages that are sent to the employees and employer to confirm disbursements.

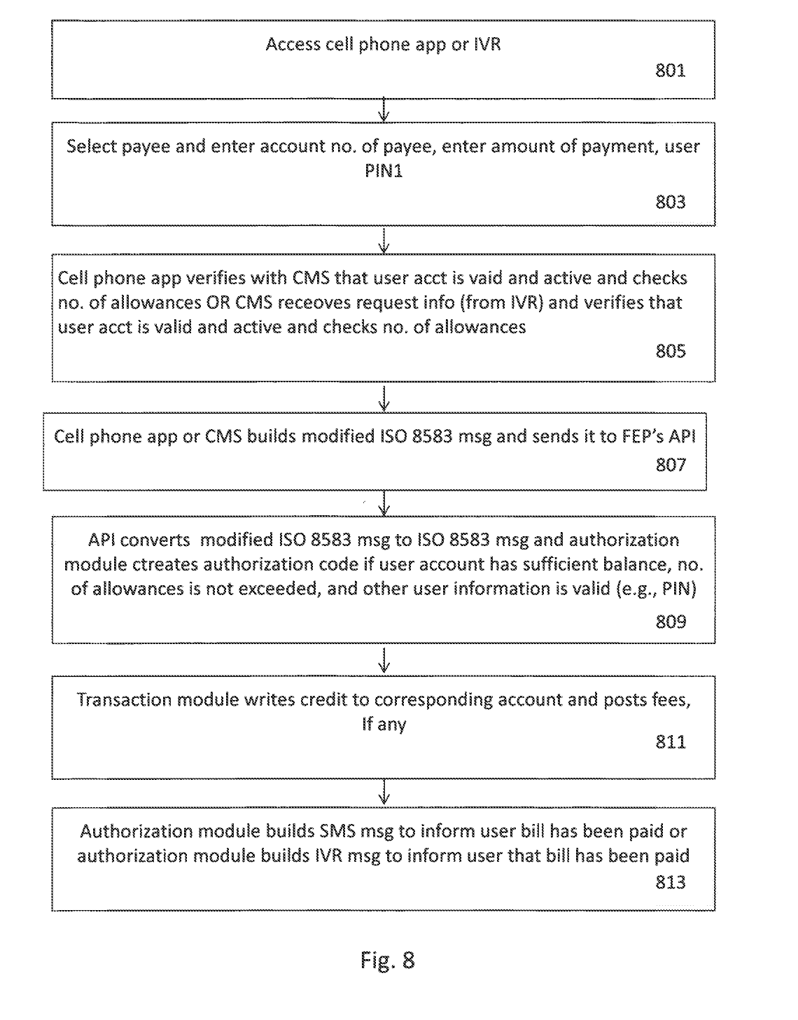

FIG. 8 illustrates a method to make payments to a payee (e.g., a utility company). In step 801 a user accesses a cell phone application or dials into an IVR system for mobile banking. In step 803 the user accesses a list of payees displayed on the cell phone or communicated to the user through the IVR interface. The user selects the payee and enters the payee account information, the amount of payment, and a PIN.

In step 805 the CMS Database verifies that the user account is active and valid and verifies that the number of allowances has not been exceeded. If the user is accessing the system through the MB interface 107, the cell phone application sends the request for verification to the CMS and does not build a modified ISO 8583 message until the CMS verifies the user account. If the user is accessing the system through the IVR interface 101, the CMS receives the request for verification but does not need to respond to the IVR interface 101.

In step 807, the cell phone application builds the modified ISO 8583 message to request the payment transaction to the system when the user requests such transaction through the MB 107. Alternatively, the CMS with a program script suited for building the modified ISO 8583 message when the user requests the transaction through the IVR 101. Then, either the MB 107 or the CMS sends the modified ISO 8583 message to the API 141.

In step 809 the API 141 converts the modified ISO 8583 message to a standard ISO 8583 message and forwards the converted message, together with parameters in the variable part of the modified ISO 8583 message, to the authorization module 139. The authorization module 139 then issues an authorization code if the user account has sufficient balance, the number of allowances has not been exceeded, and other user information is valid (e.g., PIN). In step 811 the transaction module 141 instructs the corresponding processing modules in the FEP to write a credit and debit to the corresponding accounts, together with the associated fees. In step 813, the authorization module 139 builds an SMS message to inform the user that the bill has been paid. Alternatively, the authorization module 139 builds an IVR message to inform the user through the IVR interface 101 that the bill has been paid.

As mentioned, these transactions take place without the user making use of the Internet as he or she would have to do with conventional mobile banking. The interface between the user and the system is based on a variant of the ISO 8583 as explained above. The formatting of the modified ISO 8583 message will be explained below. The messages exchanged between the server interfacing with the users and the FEP are also based on the standard ISO8583.

All of the above transactions may be metered in a Primary CMS Data Base and other modules to build the message using a specific script connected with every interface using an XML library written for the particular use, in accordance with one embodiment of the present invention. Such Data Base serves to control user activity (including fractioning transaction to hide laundering) and limits exposure or abusive usage by the clients and it may be considered a fraud prevention mechanism. Such Database is connected to the voice components, messaging, web log in and mobile banking log in. It measures the overall activity of the user accounts regardless of the interface selected by the user. For example, on the voice processing system it allows routing when a cell phone number associated to an account exists and blocks the usage when the account is flagged for any reason or it has been deactivated or doesn't exist. That call flow and information exchange may be controlled by a script managing the voice switching capability and all other interfaces exchanging the information via XML messages.

### Modified ISO 8583 Format

Financial industry services include the exchange of electronic messages relating to financial transactions. An international effort was carried out by the International Standard Organization (ISO) with a main goal of defining a unique message structure to be used by all financial institutions around the world. ISO 8583 is the name of the international standard for financial transaction card originated messages. It specifically defines a unique data structure for interchanging messages between heterogeneous financial networks. Specifically, the standard specifies a common interface by which financial transaction card originated messages may be interchanged. It specifies structure, format and content, data elements and values. One advantage of the present invention is that it allows users to conduct financial transactions, for example purchases, without the need for a credit or debit card by converting modified ISO 8583 messages so that the financial network “sees” the cardless transaction as a credit or a debit transaction in full compliance of mandatory parameters.

ISO8583 messaging structures have a series of fields where transactional related data are stored. These fields are referred to as Bitmaps. The combination of distinct bitmaps is what makes up financial transactions that could be processed by a financial institution.

The ISO8583 standard is only the main sketch to follow by a financial entity in order to implement transactional units. The application specification may remain at private level. Application designers have complete design freedom, within the overall ISO 8583 constraint, so that messages are convertible to the ISO 8583 interface format so that international interchange may take place. The idea is that financial application developers are free to implement whatever is needed if and only if their messaging interfaces can be translated to ISO8583 specifications in order to promote international interchange.

The present invention leverages the flexibility of the ISO 8583 by implementing a common messaging interface focusing on the data to be interchanged rather than the complexity of denoting and declaring ISO 8583bitmap schemes on the message. This feature is referred to herein as the Fixed Part, Variable Part Messaging Frames, interface. One of the benefits of this modified ISO 8583 interface is to ease transactional communication between third-party financial applications and the conventional back end processors which require conversion to the ISO 8583 standard.

### Fixed Part Variable Part Data Structures

In one embodiment of the present invention, data interchange between the front end modules and the end-user applications used to interface with the NBFI or bank are based on the use of the Fixed Part Variable Part Data Structures. According to this, data for transactions is put together in specific frames where every piece of data has a specific position in the frame.

The Fixed Part/Variable Part Frames are based on ISO 8583 premises. The first section of a communication frame from this implementation is referred herein as the Fixed Part and it contains all the shared information belonging to all the transactions in the system, for example, the time when the transaction was executed, the transaction code, the answer code, and others. The second section of the frame is referred herein as the Variable Part and it permits sending specific data depending on the transaction that will be executed. For example, whether the transaction that will be executed is Account Balance, then in the Variable Part of the modified ISO 8585 message basic information about the user will be sent. The Variable Part section also enables communication with non-traditional banking terminals such as mobile phones and POS devices. In one embodiment, the Fixed Part frame includes 250 characters while the Variable Part is variable in length.

The Fixed part structure may be defined as follows:

| DESCRIPTION | I/O | TYPE | LENGTH | Decimals | From | To | Values/Constraints |
|---|---|---|---|---|---|---|---|
| ApplicationCode | O | A | 2 | | 1 | 2 | Fixed value = CS: Indicates |
| | | | | | | | to FEP a transaction from |
| | | | | | | | NBFI OR BANK'S |
| | | | | | | | LICENSED OPERATOR |
| TransactionCode | O | A | 6 | | 3 | 8 | Alphanumeric indicator who |
| | | | | | | | defines codes to be |
| | | | | | | | interpreted by Core and |
| | | | | | | | corresponds to a specific |
| | | | | | | | transaction to execute |
| | | | | | | | This Field has the following |
| | | | | | | | structure: |
| | | | | | | | XXYYZZ |
| | | | | | | | XX code to indicate type of |
| | | | | | | | transaction. |
| | | | | | | | YY code to indicate the type |
| | | | | | | | of account who originates |
| | | | | | | | the transaction |
| | | | | | | | ZZ code to indicate type of |
| | | | | | | | the destination account. |
| TellerCode | O | A | 9 | | 9 | 17 | 000000000 This field may be |
| | | | | | | | filled with nine zeros. |
| Office Code | O | A | 3 | | 18 | 20 | 000 This field may be filled |
| | | | | | | | with three zeros |
| Date of Transaction | O | N | 8 | 0 | 21 | 28 | YYYYMMDD |
| | | | | | | | Example: 20090122 |
| | | | | | | | corresponds to January 22 of |
| | | | | | | | 2009. |
| Time of Transaction | O | N | 6 | 0 | 29 | 34 | HHMMSS |
| | | | | | | | Example: 142510 |
| | | | | | | | corresponds to 14 hours 25 |
| | | | | | | | minutes 10 seconds |
| Effective date of | O | N | 8 | 0 | 35 | 42 | YYYYMMDD |
| transaction | | | | | | | This field has to take the |
| | | | | | | | same value of the Date of |
| | | | | | | | Transaction field in a |
| | | | | | | | request. |
| ChannelCode | O | A | 3 | | 43 | 45 | Fixed value = IVR |
| SwitchCode | O | N | 4 | 0 | 46 | 49 | Numeric code that |
| | | | | | | | indentifies the actions to be |
| | | | | | | | followed in the Transactional |
| | | | | | | | Core |
| Device | O | A | 2 | | 50 | 51 | Fixed value = 02(Value |
| | | | | | | | changed) |
| CorrelativeNumber | O | N | 12 | 0 | 52 | 63 | Represents a counter for all |
| | | | | | | | the transactions, the code is |
| | | | | | | | reset every day. It may be |
| | | | | | | | handled by the IVR |
| | | | | | | | application. |
| Authorization | I | N | 6 | 0 | 64 | 69 | It may be filled with 000000 |
| Number | | | | | | | for the Message Module API |
| | | | | | | | invocation. Core may |
| | | | | | | | respond with a numeric |
| | | | | | | | value of 6 positions |
| Transaction Type | O | A | 1 | | 70 | 70 | 1 = Normal Transaction |
| | | | | | | | 2 = Forced Transaction |
| | | | | | | | 3 = Reversal Transaction |
| Reply Code | I | A | 5 | | 71 | 75 | It may be filled with 00099 |
| | | | | | | | for the Message Module API |
| | | | | | | | invocation. Core |
| | | | | | | | mayrespond with a numeric |
| | | | | | | | value of 5 positions |
| Reply Code | I | A | 75 | | 76 | 150 | It may be filled with 75 |
| Description | | | | | | | blanks for the Message |
| | | | | | | | Module API invocation. |
| | | | | | | | Core mayrespond with an |
| | | | | | | | alphanumeric value of 75 |
| | | | | | | | positions padded with blanks |
| | | | | | | | if necessary. |
| Filler | O | A | 99 | | 151 | 250 | It may be filled with 99 |
| | | | | | | | blanks |

As stated early, every transaction implements its own variable part depending on its nature and functionality.

The present invention allows the following transactions via the Fixed Part, Variable Part interface (i.e., the modified ISO 8583 interface):

| Processing | | | Acquiring | |
|---|---|---|---|---|
| Code | Description | Type | Chanel | Switch |
| 330000 | Balance Inquiry (Account Number) | Non Monetary | IVR | 2021 |
| 330000 | Balance Inquiry (Account Number) | Non Monetary | WEB | 2023 |
| 330000 | Balance Inquiry (Account Number) | Non Monetary | MB | 2026 |
| 311000 | Balance Inquiry (ID Number) | Non Monetary | WEB | 2023 |
| 311000 | Balance Inquiry (ID Number) | Non Monetary | MB | 2026 |
| 330000 | Balance Inquiry (Account Number) | Non Monetary | SMS | 2028 |
| 321000 | Last Monetary Movement Inquiry | Non Monetary | IVR | 2021 |
| 321000 | Last Monetary Movement Inquiry | Non Monetary | SMS | 2028 |
| 321000 | Last Monetary Movement Inquiry | Non Monetary | WEB | 2023 |
| 330000 | Balance Inquiry (Account Number) | Non Monetary | Corporate | 2024 |
| | | | WEB | |
| 330000 | Balance Inquiry (ID Number) | Non Monetary | Corporate | 2024 |
| | | | WEB | |
| 321000 | Last Monetary Movement Inquiry | Non Monetary | MB | 2026 |
| 321000 | Last Monetary Movement Inquiry | Non Monetary | Corporate | 2024 |
| | | | WEB | |
| 401030 | Third Party Transfers | Monetary | IVR | 2021 |
| 401030 | Third Party Transfers | Monetary | WEB | 2023 |
| 401030 | Third Party Transfers | Monetary | MB | 2026 |
| 500002 | Session Start | Non Monetary | Corporate | 2024 |
| | | | WEB | |
| 500002 | Session Start | Non Monetary | WEB | 2023 |
| 500002 | Session Start | Non Monetary | MB | 2026 |
| 500003 | Access PIN Change | Non Monetary | Corporate | 2024 |
| | | | WEB | |
| 500003 | Access PIN Change | Non Monetary | WEB | 2023 |
| 500003 | Access PIN Change | Non Monetary | MB | 2026 |
| 500006 | Access PIN recovery (Reset Indicator) | Non Monetary | WEB | 2023 |
| 500006 | Access PIN recovery (Reset Indicator) | Non Monetary | Corporate | 2024 |
| | | | WEB | |
| 500001 | Access PIN recovery (PIN setting) | Non Monetary | Corporate | 2024 |
| | | | WEB | |
| 500001 | Access PIN recovery (PIN setting) | Non Monetary | WEB | 2023 |
| 500007 | Access PIN recovery (Reset Indicator) | Non Monetary | WEB | 2023 |
| 500007 | Access PIN recovery (Reset Indicator) | Non Monetary | Corporate | 2024 |
| | | | WEB | |
| 330000 | Balance Inquiry # Account/Cellphone | Non Monetary | POS | 2014 |
| 340000 | Balance Inquiry # Account/Cellphone | Non Monetary | POS | 2014 |
| 001000 | Goods and Services Buy (Card) | Monetary | POS | 2014 |
| 061001 | Goods and Services buy (Cellphone) | Monetary | POS | 2014 |
| 261001 | Goods and Services buy (Cellphone) | Monetary | POS | 2014 |
| | void | | | |
| 061002 | IVR PIN Verification Goods and | Monetary | POS | 2014 |
| | Services Buy | | | |
| 261002 | IVR PIN Verification Goods and | Monetary | POS | 2014 |
| | Services Buy Void | | | |
| 201000 | Goods and Services Buy Void | Monetary | POS | 2014 |
| 021000 | Account Recharge | Monetary | POS | 2014 |
| 221000 | Account Recharge Void | Monetary | POS | 2014 |
| 031000 | Redemption | Monetary | POS | 2014 |
| 231000 | Redemption Void | Monetary | POS | 2014 |

### Cell Bank Software Application

### Functionality

The Cell Bank or Mobile Bank Application of the present invention allows NBFI or bank customers to complete common banking transactions (for example, balance inquiries, transfers) using a mobile telephone. It allows NBFI or bank customers to manage their banking accounts from any location where there is access to a mobile telephone signal or Internet connection.

The Cell Bank application of the present invention may be based on a J2ME Midlet. The J2ME Midlet enables NBFI or bank customers and the NBFI or bank to communicate on a data network using the data network operator's wireless telephone connection. The Cell Bank application of the present invention communicates with a mobile banking gateway to authorize a customer to use the application. The mobile banking gateway validates a user session and processes input and output messages to and from the Cell Bank Application. It is also responsible for communicating with the FEP to send the modified ISO 8583 messages of transactions generated.

### Application Architecture

The Cell Bank Application of the present invention may provide a series of integrated applications configured to run on a client-server scheme. In one embodiment, the client application resides on a user's mobile telephone and acquires and manages data that may be necessary for a transaction on the NBFI Electronic Payment System (EPS) network of low-value transactions or a Bank FEP using ISO 8583 conversion when assembling transactions or communications to the account. The client application uses the communication capabilities provided by the mobile telephone to initiate a data connection with intermediate servers that act as middleware between the client and the NBFI or bank.

The connectivity architecture is based on the defining characteristic of contemporary mobile telephones, that is, the ability to access the Internet through the cellular network and transfer data via the HTTP protocol. The disclosed communication architecture capitalizes on Internet accessibility, data transfer via the HTTP protocol, and the increasing computing/processing power of mobile telephones, to reduce the amount of data exchanged over the technology platforms relied upon by the Cell Bank Application.

The Cell Bank Application of the present invention may reside on the customer's mobile telephone. The application may acquire data necessary to initiate a transaction from the network of low-value transactions. That data may be translated into and sent as ciphered messages converted to XML code. The XML code may include the data for initiating a transaction and may be delivered by middleware to the server through HTTP POST. The middleware translates the forwarded data into the proper information exchange format using the modified ISO8583 of the present invention.

The XML code used to initiate a requested transaction utilizes one or more tags that may be defined in terms of the parameters needed to be included for each transaction based on the modified ISO8583 standard used in connection with the financial network of low value transactions. Additionally, to meet basic security requirements, a cryptography program may be used to secure sensitive information related to the operations of the financial system of the present invention. The cryptography program may provide lightweight yet robust protections based on encryption of sensitive information as specified, for example, in W3C: XML Encryption Syntax and Processing.

It is important to note that, preferably, only certain information is encrypted because of the high computational/processing requirements of encrypting and decrypting large amounts of data in a reasonable time. Such encryption and message conversion operates in a temporary key made as a variable division polynomial generated by the FEP session, making each transaction unique and different from the next. Accordingly, it is generally preferable to only encrypt sensitive data such as PINs, account numbers, etc. But in this case such encryption generates less data and provides unique resolution at each end. This improves system performance while adding the value of added security. The middleware server may be used to implement the API 141, for example. The middleware server may also have access to a sessions database and write information in that database to keep track of communication sessions between users and the core server. The middleware server may also have access to database which may contain information to assist with the verification or validation of user accounts, for example. The middleware server may connect to a security database which may contain information that may be used to validate PINs.

### Flow of Transaction Referrals

One feature of the Cell Bank Application of the present invention is that it allows a customer to initiate a purchase transaction at a point of sale by providing the seller only the customer's telephone number and a PIN, for example.

Taking into account the variables that come into play in this process, the transaction is classified by the point of sale device as “Card Not Present.” This designation makes a transaction of special care due to potential fraud exposure for impersonating the actual user, and for business concerns, transactions classified as “Card Not Present” are subsequently customer verified. The verification process may require that the customer be contacted by telephone, whereby the customer is prompted to confirm or reject the transaction by providing a PIN code required for monetary transactions.

As each transaction is atomic, this transaction, which is hereafter defined as a “Referral” point of sale transaction may divide into two independent steps in accordance with the present invention. In accordance with one embodiment of the present invention, the first step, a point of sale transaction is pre-authorized and is maintained on the switch as pending verification. In the second step, the point of sale transaction is the customer's self-verification. Thus the second step is used to verify the first step. Upon execution of both steps, the “Referral” point of sale transaction is complete.

A modified form of the “Referral” transaction is the “Passive Hold” transaction. The “Passive Hold” transaction is also executed using the NBFI' s or bank's network of low value transaction. In accordance with the one embodiment of the present invention, the “Passive Hold” transaction is similar to the “Referral” transaction in all respects except that the seller at the point of sale is only made aware of the existence of the transaction at the time of the transaction.

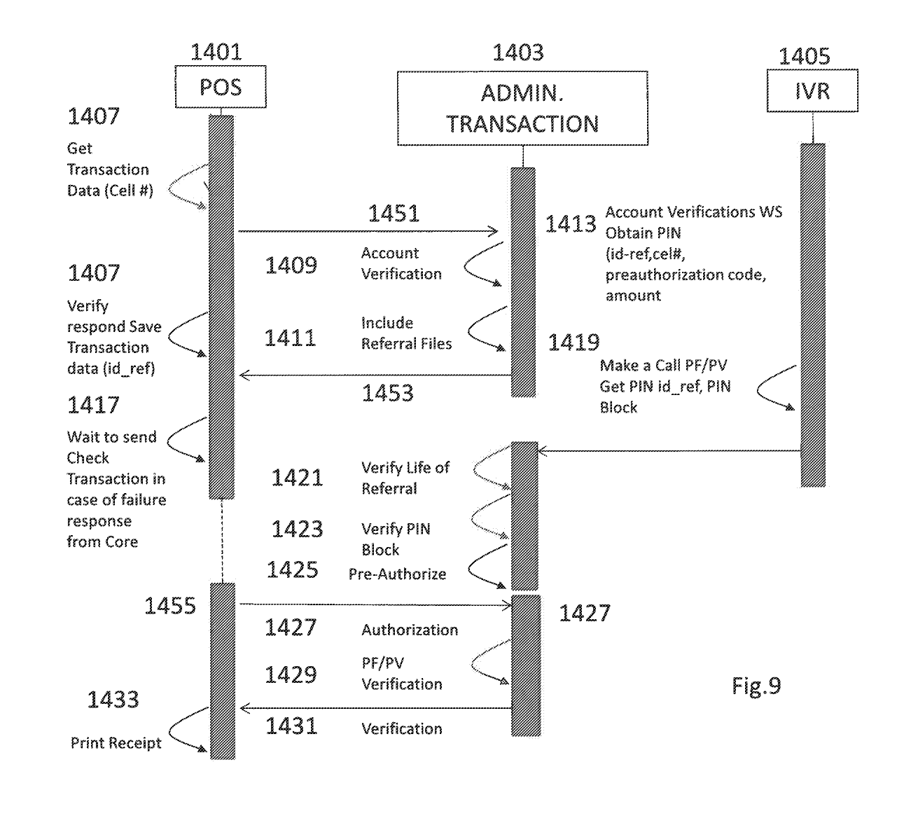

FIG. 9 illustrates a process that involves several individual transactions, in whole, properly synchronized, which are referenced to as “Referrals.”

FIG. 9 illustrates three devices or modules involved in the processing of transactions involving referrals, the POS 1401, the terminal administrator module 1403, and an IVR interface 1405, which may reside in the authorization module 139 (FIG. 1). For simplicity, the Fig. does not show the process of converting the messages from modified ISO 8583 to standard ISO 8583.

In one embodiment the transaction flow is as follows:

1. A customer initiates a purchase transaction using a mobile telephone number (no need for a plastic debit or credit card)by providing all required data for the transaction, including, for example, the customer's mobile telephone number 1407. The POS builds a message with the internally programmed Merchant ID information and a series of standard characters including transaction's parameters such as date, hour, amount and ancillary security encryption codes built for PCI Compliance for other type of transactions. The message also includes a specific code that is recognized by the FEP as a “Referral” transaction. That code is part of the transaction ID and is passed along the authorization process. The message is sent to the FEP (1451), for example, to the terminal administrator module (1403). The terminal administrator module verifies the amount of the transaction (1409) and identifies the transaction as a Referral transaction (1411). By identifying the transaction as a Referral, the system knows that completion of the overall transaction is dependent upon PIN verification over the IVR (1405). After completion of the process a temporary code is rendered. Such code is used to complete the set of all necessary parameters in the transaction at the POS described in next paragraph.

2. The mobile telephone then receives a request to confirm the transaction through the IVR system, which prompts the user to confirm the transaction with the security code (PIN1 from account activation). Upon receipt and verification of the PIN1 (1413), the IVR will communicate a onetime security code for the user to provide to the merchant. To generate a onetime use security code, the terminal administrator receiving the PIN information (1419) from the IVR verifies the life of the referral 1421, verifies PIN information 1423, and pre-authorizes the transaction 1425. Upon pre-authorization a pre-authorization code is generated and part of this code may be used as the onetime use security code (PIN2).

3. The seller at the point of sale is sent a message 1453 referencing the pending transaction 1415 along with a standby signal 1417, which can be displayed on a monitor or screen at the POS. This message is sent by the FEP in response to the Referral transaction request. The standby signal can include a friendly message such as “Processing . . . . Please wait.” By the time the standby signal is received by the seller at the point of sale, the data necessary to initiate the second step 1455 of the transaction has been sent for confirmation by the FEP. This second step may be initiated if there is one of two events:
The customer has previously successfully verified the PIN1 over the IVR, so that the customer can advise the seller at the point of sale to press an approval key or softkey on the monitor that indicates “Passive Waiting,” for example. Pressing the “Passive Waiting” softkey may be the trigger for the seller at the point of sale to communicate the transaction data verification response 1455 received as a result of the first “Referral” Transaction request.
The predetermined wait time for “passive waiting” has lapsed, so the point of sale becomes unblocked by sending 1455 the response data received from the first “Referral” transaction request to determine whether the transaction can be verified.
4. At that point the verification of the PIN has been communicated by the user/customer through the mobile telephone regardless of the event occurring in the preceding step three. The terminal administrator is then prompted to verify whether the transaction was validated by the merchant with the PIN2 1427 (In one embodiment the IVR provides PIN2 to the customer and the customer in turn provides PIN2 to the merchant). This step involves the following alternatives:
The FEP verifies that the merchant provided the correct PIN2 and the transaction is finally approved. The FEP then communicates to the seller 1431 at the point of sale that the transaction was approved and a receipt may be printed 1433.
The FEP rejects the transaction because the merchant failed to provide a correct PIN2. The FEP then communicates 1431 to the seller at the point of sale that the transaction was rejected and a proper rejection receipt may be printed 1433.
The foregoing description of possible implementations consistent with the present invention does not represent a comprehensive list of all such implementations or all variations of the implementations described. The description of only some implementation should not be construed as an intent to exclude other implementations. For example, artisans will understand how to implement the invention in many other ways, using equivalents and alternatives that do not depart from the scope of the invention. Moreover, unless indicated to the contrary in the preceding description, none of the components described in the implementations are essential to the invention. It is thus intended that the specification and examples be considered as exemplary only, with a true scope and spirit of the invention being indicated by the following claims.

1. A system for processing electronic financial transactions comprising:
at least one remote device for assembling data messages in a first format, the data messages including requests for authorization for conducting card-less financial transactions based on use of a mobile phone number as a reference to a user account (or a combination of access number, selection upon answering to multiple accounts or financial products linked to Telephone number);
an application programming interface residing in a server for receiving and converting said data messages into a second format;
an acquirer module that acquires and decoding instructions in the data messages having a second format; and
a processing module for executing instructions acquired by the acquirer module to read or write information into a back end database; wherein the acquirer module further communicates with the remote device to inform the remote device whether the requested financial transaction has been approved.

2. The system of claim 1, wherein the acquirer module includes an authorization module or a transaction module.

3. The system of claim 2, wherein the remote device includes a point-of-sale device or an electronic cash register and the acquirer module includes a terminal administration module for processing requests from the point-of-sale device or the electronic cash register.

4. The system of claim 2, wherein the authorization module verifies:
whether an account to be debited has enough balance to complete a requested transaction;
whether a PIN entered at remote device matches a PIN stored in the backend database; or
whether a number of allowances is met.

5. The system of claim 2, wherein the authorization module issues a temporary code to be used as a security token in conducting financial transactions.

6. The system of claim 5, wherein the temporary code comprises the last two digits of a session ID.

7. The system of claim 1, wherein the first format is ISO 8583 modified to include a fixed part and a variable part.

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)
